(19) United States
(12) Patent Application Publication
(10) Pub. No.: US 2006/0163531 A9
(43) Pub. Date: Jul. 27, 2006

(54) Slurry for polishing copper film and method for polishing copper film using the same

(76) Inventor: Myoung Shik Kim, Chungcheongbuk-do (KR)

Correspondence Address: LADAS & PARRY LLP, 224 SOUTH MICHIGAN AVENUE, SUITE 1600, CHICAGO, IL, 60604, US

(21) Appl. No.: 11/051,757

(22) Filed: Feb. 4, 2005

(30) Foreign Application Priority Data
Feb. 5, 2004 (KR) 10-2004-0007492

(51) Int. Cl. C09K 13/00; B44C 1/22; C23F 1/00

(52) U.S. Cl. 252/79.1; 216/88

(57) ABSTRACT

Disclosed are a slurry for polishing a copper film and a method for polishing a copper film using the slurry. A slurry containing H₂O₂ as an oxidizer and glycine as an inhibitor is prepared. Polishing of a copper film is performed in such a manner that the slurry is provided onto a polishing pad, and a copper film is contacted with the polishing pad. In the copper film polishing, no contamination occurs and surface roughness of the copper film is favorable.

### BACKGROUND OF THE INVENTION

1. Field of the Invention

The present invention relates to a slurry for polishing a copper film and a method for polishing a copper film using the polishing slurry, and more particularly to a slurry for polishing a copper film, which contains an oxidizer and an inhibitor, and a method for polishing a copper film using such a polishing slurry.

2. Description of the Prior Art

As information media such as a computer has been rapidly popularized, a semiconductor device is also making rapid progress. In view of functions, the semiconductor device is required to operate at a high speed and simultaneously have large storage capacity. To meet these requirements, manufacturing technology development of a semiconductor device is focusing on enhancing its degree of integration, reliability, response speed or the like.

Therefore, a metal film used for metal wiring of a semiconductor device must also satisfy strict requirements. According to this, the latest semiconductor device employs a copper film having relatively low resistivity and an excellent electromigration characteristic.

Since the copper film is not easy to be etched, metal wiring employing the copper film is mostly formed using a damascene technique. That is, the metal wiring is obtained by forming an insulative pattern having an opening, sufficiently filling up the opening with a copper film and then polishing the copper film. Mostly, polishing of the copper film is accomplished by chemical-mechanical polishing using a slurry. In this case, a slurry used in the chemical mechanical polishing (CMP) of the copper film contains H₂O₂ as an oxidizer and BTA as an inhibitor. Also, in order to obtain a sufficient polishing rate, H₂O₂ and BTA are so adjusted to have concentrations of at least 25 wt. % and 1 wt. %, respectively. That is, they are adjusted so that the polishing rate has a value of at least 6,000 Å/min without causing corrosion in an inlet region of the opening.

Although the polishing using a slurry can acquire a sufficient polishing rate and reduce the occurrence of corrosion, there are frequent situations in which the polishing is accompany with contamination and surface roughness of the copper film is unfavorable.

As stated just before, the conventional polishing method of a copper film has a problem in that it has a bad effect on electrical reliability of a semiconductor device due to the occurrence of contamination and the unfavorable surface roughness.

### SUMMARY OF THE INVENTION

Accordingly, the present invention has been made to solve the above-mentioned problem occurring in the prior art, and an object of the present invention is to provide a slurry for polishing a copper film, which causes no contamination and brings favorable roughness of surface to be polished even when a copper film is polished.

A further object of the present invention is to provide a method for polishing a copper film using a slurry which causes no contamination and brings favorable roughness of surface to be polished.

In order to accomplish these objects, there is provided a slurry for polishing a copper film in accordance with one aspect of the present invention, the slurry containing: H₂O₂ as an oxidizer; and glycine as an inhibitor.

In accordance with another aspect of the present invention, there is provided a method for polishing a copper film, the method comprising the steps of: preparing a slurry containing H₂O₂ as an oxidizer and glycine as an inhibitor; providing the slurry onto a polishing pad; and contacting a copper film with the polishing pad.

In this way, the present invention provides a slurry containing H₂O₂ as an oxidizer and glycine as an inhibitor, and uses the slurry for polishing a copper film. For this reason, surface roughness of the polished copper film is favorable and contamination seldom occurs even if the copper film is polished using the slurry. Also, a sufficient polishing rate is obtained and corrosion is not generated. Therefore, metal wiring made of a copper film, which is formed by polishing using a slurry in accordance with the present invention, can have a satisfactory electrical reliability.

Hereinafter, a detailed description will be given for the slurry according to the present invention.

A slurry in accordance with a preferred embodiment of the present invention contains H₂O₂ as an oxidizer and glycine as an inhibitor. Also, the slurry mostly contains alumina as abrasive particles.

Preferably, H₂O₂ has a concentration of 2.5 to 5.0 wt. %. The reason of this is that a desired polishing rate cannot be obtained if the concentration of H₂O₂ is less than 2.5 wt. %, and it is quite probable to cause contamination during polishing if the concentration of H₂O₂ is more than 5.0 wt. %.

Glycine is one of simple amino acids and mostly exists in three forms in an aqueous solution. That is, it exists in the form of ⁺H3NCH2COOH, ⁺H3NCH2COO⁻ or H3NCH2COO⁻. The following chemical formula shows the reaction mechanism between copper ions contained a copper film and the slurry containing glycine, which exist in an aqueous solution phase, in a range of pH about 4:
Cu²⁺+H3NCH2COO⁻═Cu(H2NCH2COO)⁺+H→Cu(H2NCH2COO)⁺+H═Cu(H3NCH2COO)²⁺→Cu(H2NCH2COO)⁺+⁺H3NCH2COO⁻═Cu(H2NCH2COO)₂+2H⁺→Cu(H2NCH2COO)₂+e=Cu(H2NCH2COO)₂⁻

It can be confirmed from the above reaction mechanism that glycine serves to reduce an electron, which causes corrosion, through the reaction. It can be also confirmed that a reaction rate of copper ions and glycine is increased. Therefore, it can be concluded that when a slurry containing glycine is used for polishing a copper film, corrosion of the copper film is reduced and its polishing rate is increased. In particular, since the slurry maintains a stable state when it has pH of 4, pH of the slurry is preferably adjusted to 4 to 5. Also, a concentration of glycine less than 0.05 mol disadvantageously deteriorates the polishing rate and a concentration of glycine more than 0.1 mol is obstacle to reducing the occurrence of corrosion. Thus, it is preferred that glycine has a concentration of 0.05 to 0.1 mol.

In this way, the slurry according to the present invention causes no corrosion and simultaneously provides a sufficient polishing rate in polishing a copper film. It also can reduce the occurrence of contamination and secure favorable surface roughness of the polished copper film.

### BRIEF DESCRIPTION OF THE DRAWINGS

The above and other objects, features and advantages of the present invention will be more apparent from the following detailed description taken in conjunction with the accompanying drawings, in which:

FIG. 1 is a process flowchart for explaining a method for polishing a copper film in accordance with a preferred embodiment of the present invention;

FIG. 2 is a schematic constructional view for explaining a chemical mechanical polishing apparatus which is applied to a method for polishing a copper film in accordance with a preferred embodiment of the present invention; and

FIGS. 3a to 3c are sectional views for explaining a method for polishing a copper film in accordance with a preferred embodiment of the present invention.

### DETAILED DESCRIPTION OF THE PREFERRED EMBODIMENTS

Hereinafter, a preferred embodiment of a method for polishing a copper film in accordance with a preferred embodiment of the present invention will be described with reference to the accompanying drawings. In the following description and drawings, the same reference numerals are used to designate the same or similar components, and so repetition of the description on the same or similar components will be omitted.

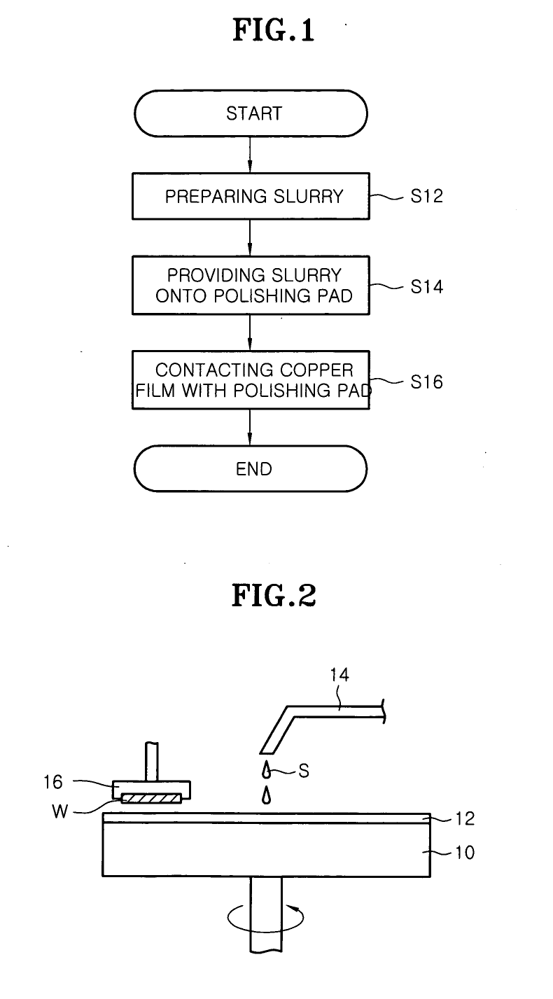

FIG. 1 shows a process flowchart for explaining a method for polishing a copper film in accordance with a preferred embodiment of the present invention.

Referring to the drawing, first of all, a slurry for polishing the copper film is prepared (S12). That is, the slurry is adjusted to pH about 4, and contains H₂O₂ having a concentration of about 3.0 wt. % as an oxidizer and glycine having a concentration of 0.07 mol as an inhibitor.

Thereafter, the slurry is provided onto a polishing pad (S14). That is, referring to FIG. 2 which shows a schematic constructional view of a chemical-mechanical polishing apparatus to be applied to a method for polishing a copper film, the slurry S is provided onto the polishing pad 12 located on a rotating base plate 10 through a nozzle 14. At this time, a substrate W forming with a copper film is grasped by a carrier head 16.

Next, the substrate W grasped by the carrier head 16 is contacted with the polishing pad 12 (S16). That is, by contacting the copper film formed on the substrate W with the polishing pad 12, the copper film comes to be polished. Also, since the rotating base plate 10 and the carrier head 16 are rotated during the polishing, the copper film can be efficiently polished.

The copper film polishing as stated above is mostly applied to a process in which the copper film is formed into metal wiring using a damascene technique. To be concrete, such a process progresses as follows:

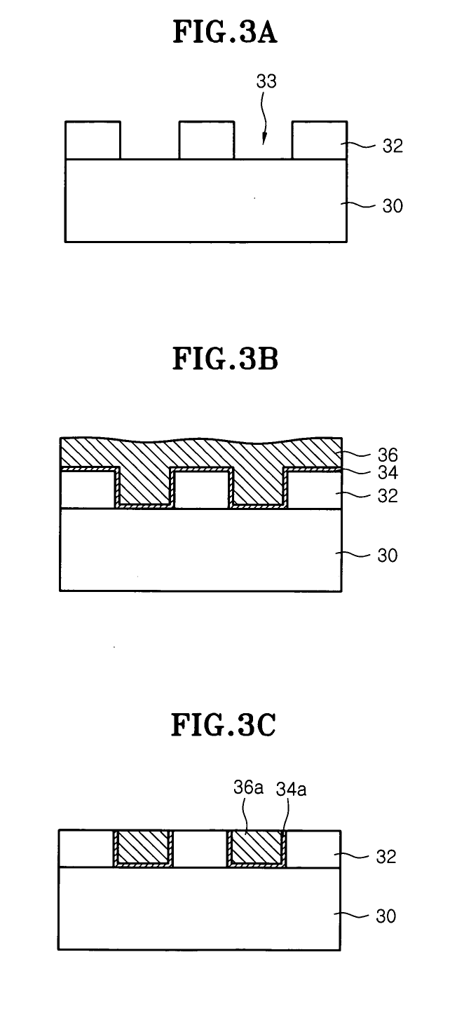

Referring to FIG. 3a, an insulative film is formed on a substrate 30. The insulative film is patterned to form an insulative film pattern 32 having an opening 33. This opening 33 corresponds to a contact hole or a via hole. Referring to FIG. 3b, a barrier metal film 34 is consecutively formed on a surface of the insulative film pattern 32, sidewalls of the opening 33 and a bottom surface of the opening 33. An example of the barrier metal film 34 includes a tantalum nitride film, a titanium nitride film or the like. Next, the resultant structure having the opening 33 is deposited with a copper film 36 such that the opening 33 is sufficiently filled up with the copper film 36. Referring to FIG. 3c, the copper film 36 is polished. At this time, polishing of the copper film is performed until a surface of the insulative film pattern 32 is exposed. In this way, there can be obtained metal wiring having a damascene structure in which a barrier metal film pattern 34a and a copper film pattern 36a are formed only within the opening 33.

The slurry according to the present invention is used in the above-mentioned copper film polishing. Consequently, a sufficient polishing rate is secured and corrosion seldom occurs. Also, since a concentration of an oxidizer is adjusted and glycine is used as an inhibitor, no contamination occurs and the obtained copper film pattern has favorable surface roughness even if the polishing is performed using a slurry.

As described above, according to the present invention, it is possible to secure sufficient electrical reliability even when metal wiring of a copper film having a damascene structure is obtained through chemical mechanical polishing. Accordingly, a semiconductor device having high reliability can be also obtained.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A slurry for polishing a copper film, the slurry containing:
H₂O₂ as an oxidizer; and
glycine as an inhibitor.

2. The slurry as claimed in claim 1, wherein H₂O₂ has a concentration of 2.5 to 5.0 wt. %.

3. The slurry as claimed in claim 1, wherein glycine has a concentration of 0.05 to 0.1 mol.

4. The slurry as claimed in claim 1, wherein glycine has pH of 4 to 5.

5. A method for polishing a copper film of a semiconductor device, the method comprising the steps of:
preparing a slurry containing H₂O₂ as an oxidizer and glycine as an inhibitor;
providing the slurry onto a polishing pad; and
contacting a copper film with the polishing pad.

6. The method as claimed in claim 5, wherein H₂O₂ has a concentration of 2.5 to 5.0 wt. % and glycine has a concentration of 0.05 to 0.1 mol.

7. The method as claimed in claim 5, wherein the slurry containing glycine has a pH of 4 to 5.

8. The method as claimed in claim 5, wherein the copper film is formed on a structure having an opening.
